(19) United States
(12) Patent Application Publication
(10) Pub. No.: US 2005/0097923 A1
(43) Pub. Date: May 12, 2005

(54) System and support rod assembly for sintering fiber optic sleeve tubes

(75) Inventors: David Charles Pender, Aachen (DE); Frederic Joseph Klug, Schenectady, NY (US); Robert Arthur Giddings, Slingerlands, NY (US); Thomas Francis McNulty, Ballston Lake, NY (US); Thomas Joseph Cartier JR., Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/712,729

(22) Filed: Nov. 12, 2003

(51) Int. Cl. C03B 37/10

(52) U.S. Cl. 65/427; 65/374.13; 65/374.15

(57) ABSTRACT

A system for sintering a quartz tube, such as a quartz fiber optic sleeve tube. The system comprises a furnace for heating the quartz tube to a temperature of at least 1400° C. in a controlled atmosphere, a support rod assembly for the quartz tube, and means for positioning the quartz tube and a portion of the support rod assembly within the furnace. The support rod assembly includes a cylindrical support rod that straightens and supports the quartz tube and prevents tapering of the inner diameter due to creep, and at least one retaining portion coupled to at least one end of the cylindrical support rod for preventing slippage of the quartz tube from the support rod assembly. A mandrel assembly for fabricating a quartz fiber optic sleeve tube, a method of making a quartz fiber optic sleeve tube using the mandrel assembly, and a quartz fiber optic sleeve tube are also disclosed.

### BACKGROUND

The invention relates to a mandrel assembly for forming a fiber optic sleeve tube. More particularly, the invention relates to a mandrel assembly for forming a quartz fiber optic sleeve tube, wherein the mandrel assembly includes an inner support rod.

Optical fibers are widely used in a variety of applications, such as medicine, industrial inspection, and communications. The outer layers of such fibers are typically drawn from quartz fiber optic sleeve tubes. Quartz fiber optic sleeve tubes are formed by first depositing a layer of silica soot onto a quartz mandrel tube via a flame hydrolysis reaction. The soot layer and quartz mandrel tube are then consolidated, or sintered, at high temperature to form the quartz fiber optic sleeve tube.

Dimensional control is very important for such fiber optic sleeve tubes. The inner diameter of the quartz mandrel tube may vary along the length of the quartz mandrel tube if the silica soot layer is non-uniform. Shrinkage and sagging due to creep occurring during consolidation may result in a fiber optic sleeve tube having a non-circular cross-section, which renders the sleeve tube unacceptable for its intended purpose. In addition, the quartz fiber optic sleeve tube must be substantially straight; any bowing of the part due to either non-uniform soot deposition or non-straight mandrels makes the sleeve tube unsuitable for its intended purpose.

Shrinkage and bowing problems have been previously addressed either through tight control of the soot deposition process or by finishing and machining the quartz sleeve tube after sintering. The degree of control that is required for uniform soot deposition is frequently difficult to achieve and results in a low yield of acceptable parts. Additional machining of the sintered quartz sleeve tube, on the other hand, is expensive and requires additional cleaning steps.

Currently, quartz fiber optic sleeve tubes are highly susceptible to dimensional variations that result in unacceptability for their intended use. Therefore, what is needed is a mandrel assembly that will reduce shrinkage and bowing of the quartz mandrel and the resulting sleeve tube. What is also needed is a support rod that will provide adequate support for a quartz mandrel during consolidation. What is further needed is a method of making a quartz fiber optic sleeve tube that meets the dimensional tolerances required for fiber optic manufacture.

### SUMMARY OF INVENTION

The present invention meets these and other needs by providing a mandrel assembly that supports the quartz mandrel during consolidation of the soot layer and quartz mandrel. In addition, the invention provides a cylindrical support rod for the mandrel assembly and a method of making a quartz fiber optic sleeve tube using the mandrel assembly.

Accordingly, one aspect of the invention is to provide a system for sintering a quartz tube. The quartz tube has a cylindrical wall defining an annular space and an outer layer of silica soot deposited on its outer surface. The system comprises: a furnace for heating the quartz tube to a temperature of at least 1400° C. in a controlled atmosphere, the furnace having a heating zone in which the quartz tube is sintered; a support rod assembly disposable in the annular space; and means for positioning the quartz tube and a portion of the support rod assembly within the heating zone. The support rod assembly comprises: (i) a cylindrical support rod having a central portion, the central portion having a surface roughness of from about 0.1 micron to about 4 microns, wherein the central portion has an ovality of up to about 0.5 mm and a bow of up to about 0.7 mm/m along a longitudinal axis of the support rod assembly, wherein the cylindrical support rod has a coefficient of thermal expansion that is greater than a coefficient of thermal expansion of the quartz tube, wherein the support rod assembly is substantially chemically inert with respect to silica in an atmosphere comprising an inert gas and at least one of fluorine, chlorine, and combinations thereof at temperatures of at least 1400° C., and wherein the support rod assembly straightens and supports the quartz tube and prevents tapering of the inner diameter due to creep; and (ii) at least one retaining portion coupled to the at least one end of the cylindrical support rod for preventing slippage of the quartz tube from the support rod assembly.

A second aspect of the invention is to provide a support rod assembly for supporting a quartz tube during sintering. The support rod assembly comprises: a cylindrical support rod having a central portion, the central portion comprising a carbonaceous material and having a surface roughness of from about 0.1 micron to about 4 microns, wherein the central portion has an ovality of up to about 0.5 mm and a bow of up to about 0.7 mm/m along a longitudinal axis of the support rod assembly, wherein the central portion straightens and supports the quartz tube and prevents tapering of the inner diameter due to creep, and wherein the cylindrical support rod has a coefficient of thermal expansion that is greater than a coefficient of thermal expansion of the quartz tube and is substantially chemically inert with respect to silica in an atmosphere comprising an inert gas and at least one of fluorine, chlorine, and combinations thereof at temperatures of at least 1400° C.; and at least one retaining portion coupled to at least one end of the cylindrical support rod for preventing slippage of the quartz tube from the support rod assembly.

A third aspect of the invention is to provide a system for sintering a quartz fiber optic sleeve tube. The system comprises: a furnace for heating the quartz tube to a temperature of at least 1400° C. in a controlled atmosphere, the furnace having a heating zone in which the quartz tube is sintered; a support rod assembly for supporting the quartz tube during sintering; and means for positioning the support rod assembly and the quartz tube within the heating zone. The support rod assembly comprises: (i) a cylindrical support rod having a central portion, the central portion comprising a carbonaceous material and having a surface roughness of from about 0.1 micron to about 4 microns, wherein the central portion has an ovality of up to about 0.5 mm and a bow of up to about 0.7 mm/m along a longitudinal axis of the support rod assembly, wherein the central portion straightens and supports the quartz tube and prevents tapering of the inner diameter due to creep, and wherein the cylindrical support rod has a coefficient of thermal expansion that is greater than a coefficient of thermal expansion of the quartz tube and is substantially chemically inert with respect to silica in an atmosphere comprising an inert gas and at least one of fluorine, chlorine, and combinations thereof at temperatures of at least 1400° C.; and (ii) at least one retaining portion coupled to at least one end of the cylindrical support rod for preventing slippage of the quartz tube from the support rod assembly.

A fourth aspect of the invention is to provide a method of making a quartz fiber optic sleeve tube. The method comprises the steps of: providing a quartz tube, the quartz tube having a cylindrical wall defining an annular space and an outer layer of silica soot deposited on an outer surface thereof; providing a cylindrical support rod, wherein the cylindrical support rod has an ovality of up to about 0.5 mm and has a bow of less than about of up to about 0.7 mm/m along its longitudinal axis, and wherein the cylindrical support rod has a coefficient of thermal expansion greater than a coefficient of thermal expansion of the quartz tube, and has a surface roughness of from about 0.1 micron to about 4 microns; disposing the cylindrical support rod in the annular space of the quartz tube; and consolidating the outer layer of silica soot and the quartz tube at a first temperature, wherein the cylindrical support rod supports the quartz tube at the first temperature, and wherein consolidating the outer layer of silica soot and the quartz tube at the first temperature forms the fiber optic sleeve tube.

A fifth aspect of the invention is to provide a quartz fiber optic sleeve tube. The quartz fiber optic sleeve tube comprises a cylindrical wall defining an annular space therein. The cylindrical wall is substantially parallel to a longitudinal axis. The annular space has an ovality of up to about 0.5 mm and the quartz fiber optic sleeve tube has a bow of less than about of up to about 0.7 mm/m along the longitudinal axis. The quartz fiber optic sleeve tube is formed by: providing a quartz tube, the quartz tube having a cylindrical wall defining an annular space and an outer layer of silica soot deposited on an outer surface thereof; providing a cylindrical support rod, wherein the cylindrical support rod has a coefficient of thermal expansion that is greater than a coefficient of thermal expansion of the quartz tube, is substantially chemically inert with respect to silica in an atmosphere comprising an inert gas and at least one of fluorine, chlorine, and combinations thereof at temperatures of at least about 1400° C., has a surface roughness of from about 0.1 micron to about 4 microns, and has a bow of less than about of up to about 0.7 mm/m along the longitudinal axis; disposing the cylindrical support rod in the annular space of the quartz tube; and consolidating the outer layer of silica soot and the quartz tube at a first temperature, wherein the cylindrical support rod supports the quartz tube at the first temperature, and wherein and consolidating the outer layer of silica soot and the quartz tube at the first temperature forms the fiber optic sleeve tube.

A sixth aspect of the invention is to provide a mandrel assembly for fabricating a quartz fiber optic sleeve tube. The mandrel assembly comprises: a quartz tube, the quartz tube having a cylindrical wall defining an annular space and an outer layer of silica soot deposited on an outer surface thereof; and a cylindrical support rod disposed in the annular space. The cylindrical support rod has a coefficient of thermal expansion that is greater than a coefficient of thermal expansion of the quartz tube. The cylindrical support rod is substantially chemically inert with respect to silica in an atmosphere comprising an inert gas and at least one of fluorine, chlorine, and combinations thereof at temperatures of at least 1400° C., and has a surface roughness of from about 0.1 micron to about 4 microns. The cylindrical support rod straightens and supports the quartz tube and prevents tapering of the inner diameter due to creep.

These and other aspects, advantages, and salient features of the present invention will become apparent from the following detailed description, the accompanying drawings, and the appended claims.

### BRIEF DESCRIPTION OF DRAWINGS

FIG. 1 is a schematic representation of a quartz mandrel tube of the prior art;

FIG. 2 is a schematic representation of a quartz fiber optic sleeve tube of the prior art that has undergone creep during sintering;

FIG. 3 is a schematic representation of a quartz fiber optic sleeve tube of the prior art that has undergone bowing during sintering;

FIG. 4 is a schematic representation of a cross section of a quartz fiber optic sleeve tube of the prior art that has undergone radial shrinkage during sintering and having a high degree of ovality;

FIG. 5 is a schematic representation of a system of the present invention for sintering a quartz tube in which the support rod assembly and quartz tube are vertically suspended into a sintering furnace; and

FIG. 6 is a schematic representation of a system of the present invention for sintering a quartz tube in which the support rod assembly and quartz tube are supported from below the sintering furnace;

FIG. 7 is a schematic representation of a first embodiment of a retaining portion of the support rod assembly of the present invention;

FIG. 8 is a schematic representation of a second embodiment of a retaining portion of the support rod assembly of the present invention;

FIG. 9 is a schematic representation of a first embodiment of a second retaining portion of the support rod assembly of the present invention;

FIG. 10 is a schematic representation of a second embodiment of a second retaining portion of the support rod assembly of the present invention;

FIG. 11 is a schematic representation of a mandrel assembly of the present invention;

FIG. 12 is a schematic representation of a cylindrical support rod of the present invention;

FIG. 13 is a schematic representation of a quartz fiber optic sleeve tube formed using the mandrel assembly of the present invention;

FIG. 14 is a plot comparing percent variation of cross-sectional areas of quartz tubes that were sintered without using the support rod of the present invention and quartz tubes that were sintered using the support rod of the present invention; and

FIG. 15 is a plot comparing bow of quartz tubes that were sintered without using the support rod of the present invention and quartz tubes that were sintered using the support rod of the present invention.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms.

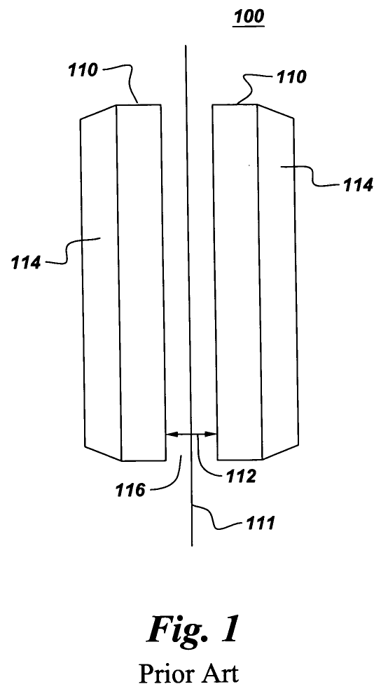

FIG. 1 shows a prior-art quartz mandrel tube 100 used to form fiber optic sleeve tubes. A silica soot layer 114 is deposited onto quartz mandrel tube 110 via a flame hydrolysis reaction. The silica soot layer 114 and quartz mandrel tube 110 are then consolidated—or sintered—at high temperature to form a quartz fiber optic sleeve tube. It is understood that the terms such as “sintering,” “consolidating,” and “consolidation” are used interchangeably throughout the description of the present invention.

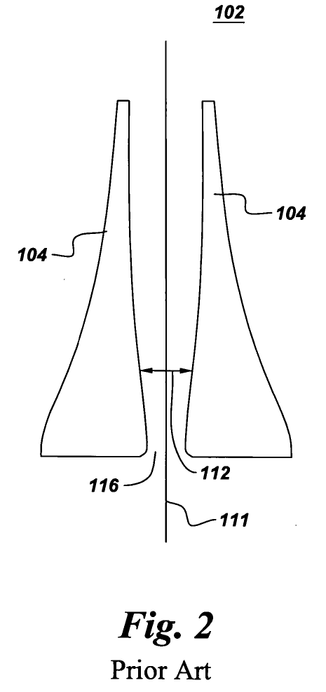

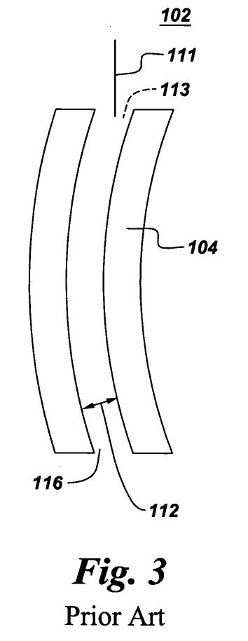

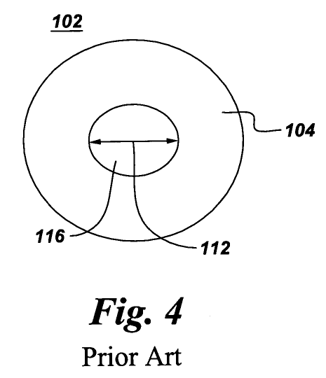

Dimensional control is important for such fiber optic sleeve tubes. Quartz mandrel tube 110 defines an inner annular space 116 having a circular cross-section and an inner diameter 112. FIG. 2 shows a fiber optic sleeve tube 102 of the prior art, in which the walls 104 have sagged and slumped as a result of creep. In addition, radial shrinkage during sintering has caused inner annular space 116 to shrink. If the silica soot layer 114 is non-uniform, the inner diameter 112 of quartz mandrel tube 110 may vary along the length of quartz mandrel tube 110, causing portions of the quartz mandrel tube 110 to sag and portions of the inner diameter 112 to shrink. Axial shrinkage and sagging result in a fiber optic sleeve tube 102 having an annular space 116 that has a non-circular cross-section, which renders fiber optic sleeve tube 102 unacceptable for its intended purpose. In addition, the quartz fiber optic sleeve tube 102 must be substantially straight; any bowing of the part due to either non-uniform soot deposition or non-straight mandrels makes the sleeve tube unsuitable for its intended purpose. FIG. 3 shows a fiber optic sleeve tube 102 of the prior art, in which the walls 104 have bowed as a result of sintering. Inner annular space 116 may also develop a high degree of ovality as a result of uneven deposition of soot or sagging during sintering. Such ovality makes the quartz fiber optic sleeve tube unacceptable for its intended purpose as well. FIG. 4 is a schematic cross-sectional view of a quartz fiber optic sleeve tube 102 with inner annular space 116 having a degree of ovality.

Previously, shrinkage and bowing problems have been addressed either through tight control of the soot deposition process or through further finishing and machining steps after the quartz sleeve tube has been sintered. However, the degree of control that is required for uniform soot deposition is frequently difficult to achieve and results in a low yield of acceptable parts. Additional machining of the sintered quartz sleeve tube, on the other hand, is expensive and requires additional cleaning steps.

In addition to preventing shrinkage and bowing during sintering, retention of the quartz mandrel tube during the sintering/consolidation process also presents a problem. The quartz mandrel tube is usually suspended vertically in a sintering furnace. The quartz mandrel tube may have a flared upper end that engages a coupling means that permits the quartz mandrel tube to be suspended in the sintering furnace. Due to thermal stresses encountered during consolidation, the quartz mandrel tube tends to fracture a short distance below the coupling means, causing the remainder of the quartz mandrel tube to fall and break.

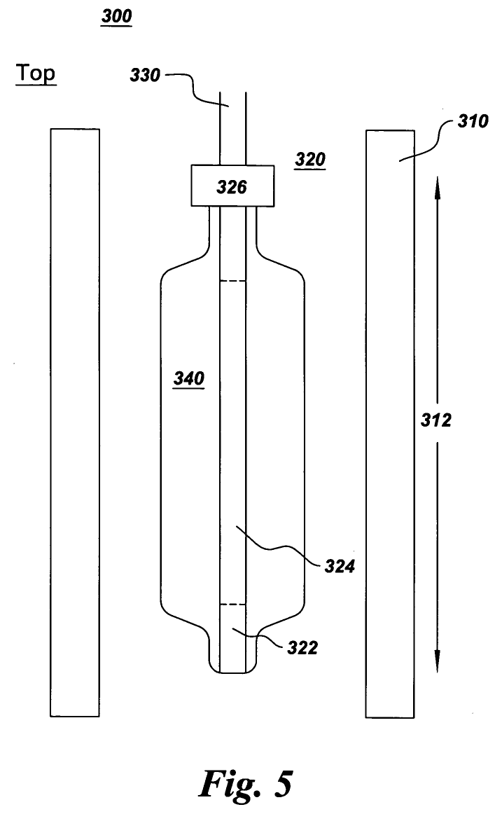

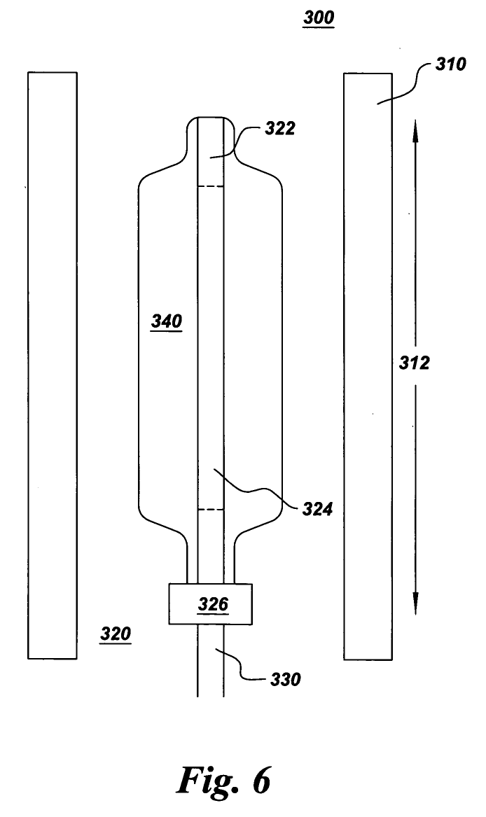

The present invention addresses the problems of shrinkage and bowing of the quartz mandrel tube during sintering as well as retention of the quartz mandrel tube by providing a system, shown in FIGS. 5 and 6, for sintering a quartz tube (also referred to hereinafter as “a quartz mandrel tube”) and a support rod assembly for supporting a quartz tube during sintering. The quartz tube 340 has a layer of silica soot deposited on its outer surface and a cylindrical wall defining an annular space therein. The system 300 comprises a furnace 310 for heating the quartz tube 340 to a temperature of at least 1400° C. in a controlled atmosphere, a support rod assembly 320 that is disposable in the annular space in quartz tube 340, and a means for positioning 330 quartz tube 340 and a portion of support rod assembly 320 and within a heating zone 312 of furnace 310.

Furnace 310 may be any furnace known in the art that has a heating zone 312 that is capable of heating quartz tube 340 to a sintering temperature of at least 1400° C. in a controlled atmosphere. A non-limiting example of such a furnace is a resistively heated furnace. Alternatively, furnace 310 may also be a gas-fired hydrogen or methane furnace or an inductively heated furnace. The controlled atmosphere with heating zone 312 of furnace 310 comprises at least one inert or nonreactive gas, such as, but not limited to helium, argon, nitrogen, combinations thereof, and the like. Helium is preferably used to produce a quartz sleeve tube of optimum optical quality.

Means for positioning 330 serve to position quartz tube 340 and a portion of support rod assembly 320 within heating zone 312 of furnace 310. In one embodiment, shown in FIG. 5, means for positioning 330 is located above furnace 310 and suspends support rod assembly 320 and quartz tube 340 into furnace 310. Alternatively, means for positioning 330 are located below furnace 310, so as to provide support for support rod assembly 320 and quartz tube 340 from below, as shown in FIG. 6. In one embodiment, means for positioning 330 comprises a rod, such as, but not limited to, a quartz rod or a graphite rod, and is affixed to a structural support element capable of supporting and maintaining support rod assembly 320 and quartz tube 340 in position within furnace 310. Means for positioning 330 may further include a drive system (not shown), such as those that are presently known in the art, that is capable of moving quartz tube 340 and support rod assembly 320 into—or through—heating zone 312 of furnace 310. In another embodiment, means for positioning quartz tube 340 is coupled to furnace 310 and moves furnace 310 with respect to quartz tube 340, thus allowing quartz tube 340 and support rod assembly 320 to either be positioned in or passed through heating zone 312. In this embodiment, means for positioning 330 may include a drive system(not shown), such as those that are presently known in the art, for moving furnace 310. In a third embodiment of the invention, means for positioning 330 moves quartz tube 340 and support rod assembly 320 into—or through—heating zone 312 by moving both furnace 310 and quartz tube 340 with respect to each other.

Support rod assembly 320 engages a portion of quartz tube 340 to retain and support quartz tube 340 during sintering. Support rod assembly 320 comprises a cylindrical support rod 322 that is disposable in the annular space of quartz tube 340 and at least one retaining portion 326 for retaining and preventing slippage of quartz tube 340. The at least one retaining portion 326 is coupled to at least one of an end portion of quartz tube 340 and an end portion of cylindrical support rod 322.

As seen in FIGS. 5 and 6, cylindrical support rod 322 has a central portion 324. Central portion 324 has a smooth outer surface; i.e., the outer surface of central portion 324 has a surface roughness from about 0.1 micron to about 4 microns. The smoothness of central portion 324 minimizes the number of sites from which catastrophic defects in quartz tube 340 may originate. Central portion 324 substantially round and straight; i.e., central portion 324 has an ovality of up to 0.5 mm and a bow of up to about 0.7 mm/m along the longitudinal axis of cylindrical support rod 322. When quartz tube 340 contacts the central portion 324 the central portion 324 supports the quartz tube 340 and reduces creep. The low degrees of bow and ovality of central portion 324 help prevent minimize bowing and axial shrinking of quartz tube 340 as a result of the sintering process and produce a sintered quartz tube, such as, but not limited to, a fiber optic sleeve tube, that is straight and has a low degree of ovality. In one embodiment, central portion 324 has an outer diameter of between about 15 mm and about 50 mm. Central portion 324 may have a length of between about 750 mm to about 1500 mm. At sintering temperatures, central portion 324 expands to contact and support quartz tube 340. The outer diameter of central portion 324 and cylindrical support rod 322 at room temperature (about 25° C.) must be less than the diameter of the annular space of quartz tube 340 in order to permit insertion of cylindrical support rod 322 into the annular space. The outer diameter of central portion 324 and support tube 322 differs over the length of central portion 324 by up to about 0.1 mm from the diameter of the annular space of quartz tube 340. If, however, the outer diameter of central portion 324 and support tube 322 differs over the length of central portion 324 differ by more than about 0.1 mm from the diameter of the annular space of quartz tube 340, cylindrical support rod 322 and central portion 324 will not contact and support quartz rod 340.

Cylindrical support rod 322 has a coefficient of thermal expansion that is greater than that of quartz tube 340. Support rod assembly 320 is substantially chemically inert with respect to silica at temperatures from about 1400° C. to about 1600° C. in an atmosphere comprising an inert gas and at least one of fluorine, chlorine, and combinations thereof; i.e., under the above conditions, reaction is limited to a surface region of cylindrical support rod 322 and the structural integrity of cylindrical support rod 322 is unaffected. In one embodiment, support rod assembly 320 is substantially chemically inert with respect to silica at temperatures from about 1400° C. to about 1600° C. in an atmosphere comprising helium and chlorine.

In one embodiment, central portion 324 is formed from a carbonaceous material, such as, but not limited to, graphite. Graphite may optionally be previously purified in the presence of chlorine gas at a predetermined temperature and have an ash content of less than 100 parts per million (ppm).

In another embodiment, central portion 324 further includes an outer coating (not shown) disposed on an outer surface of the central portion 324. Such an outer coating comprises at least one of graphite deposited by chemical vapor deposition, amorphous carbon, and boron nitride. Outer coating preferably has a surface roughness from about 0.1 micron to about 4 microns. In one embodiment, the coating is deposited on a central portion 324 comprising an alumina core or tube.

Cylindrical support rod 322 may be a single piece that incorporates central portion 324. Alternatively, cylindrical support rod 322 may comprise several pieces or segments that may be matingly joined together. In one non-limiting example, cylindrical support rod 322 comprises a first end, central portion 324, and a second end, wherein the three pieces are joined together by joining means, such as, but not limited to, threaded rods or the like, that are widely known in the art. At least one of the first end and second end may be adapted to mate or engage with the at least one retaining portion 326. In one non-limiting example, a first end is flared so as to engage the at least one retaining portion 326. Both cylindrical support rod 322 and central portion 324 are formed from either at least one solid piece of material, at least one tubular piece of material, or combinations thereof. In one embodiment, cylindrical support rod 322 and central portion comprise a solid graphite rod.

At least one retaining portion 326 secures quartz tube 340 and cylindrical support rod 322 by coupling to at least one of quartz tube 340 and cylindrical support rod 322. In addition, the at least one retaining portion 326 couples support rod assembly 320 and quartz tube 340 to means for positioning 330.

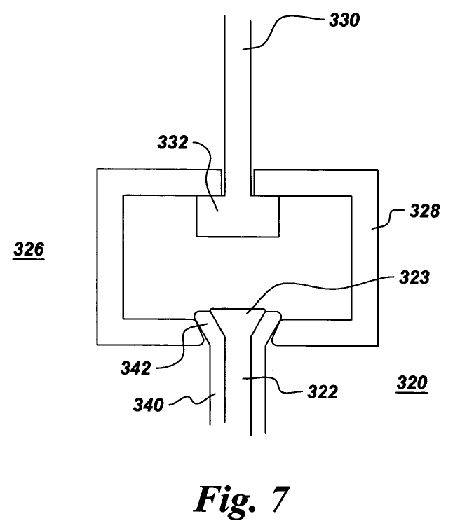

In one embodiment, shown in FIG. 7, at least one retaining portion 326 comprises a two-piece cylindrical collar 328 having a first aperture and a second aperture. Each of quartz tube 340 and cylindrical support rod 322 has a flared end 342 and 323, respectively. In one embodiment, shown in FIG. 7, flared end 342 of quartz tube 340 has a diameter that is greater than the diameter of the first aperture. Cylindrical support rod 322 is disposed in the annular space of quartz rod 340 so that the flared end 323 of cylindrical support rod 322 engages flared end 342 of quartz rod 340. When the two pieces of the two-piece cylindrical collar 328 are joined, quartz tube 340 and cylindrical support rod 322 are retained as flared end 342 engages a portion of two-piece cylindrical collar 328 in the vicinity of the first aperture.

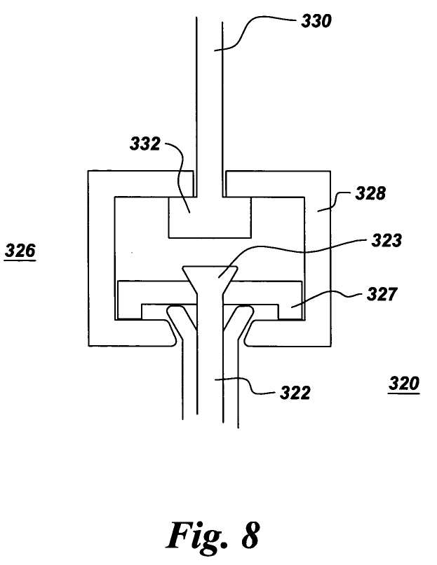

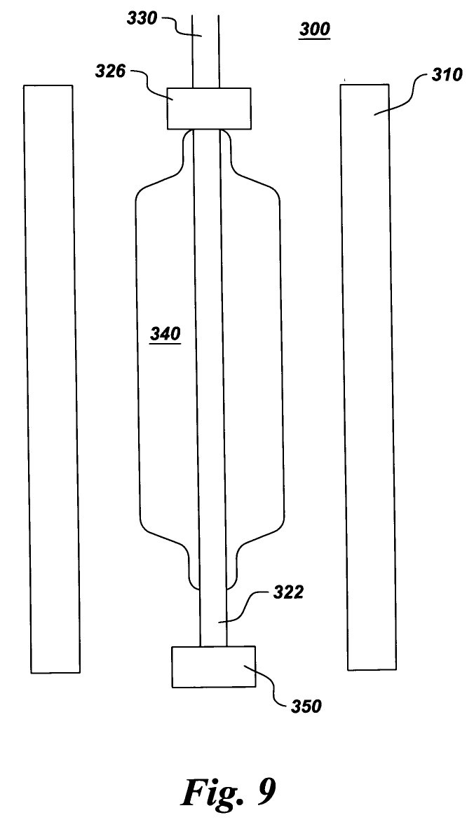

In another embodiment, shown in FIG. 8, two piece cylindrical collar 328 supports cylindrical support rod 322 by engaging flared end 323 of cylindrical support rod 322 with support shelf 327. Support shelf 327 has an aperture having a diameter that is less than that of flared end 323. In this embodiment, quartz tube 340 may also be supported by engaging flared end 342 with a portion of the two-piece cylindrical collar 326 in the vicinity of the first aperture. Alternatively, quartz tube 340 may, in this particular embodiment, be retained by a second retaining portion 350, shown in FIG. 9, located at a distal end of cylindrical support rod 322.

At least one retaining portion 326 also engages positioning means 330, and thus couples quartz rod 340 and cylindrical support rod 322 to positioning means 330. As seen in FIGS. 7 and 8, positioning means 330 includes a stop 332 having a diameter that is greater than that of second aperture of two-piece cylindrical collar 328. Two-piece cylindrical collar 328 engages stop 332 in the vicinity of the second aperture.

Other means that are known in the art, such as, but not limited to, threaded rods, set screws, interference fits, and the like, may also be incorporated into the at least one retaining portion to engage and support positioning means 330, quartz tube 340, and cylindrical support rod 322.

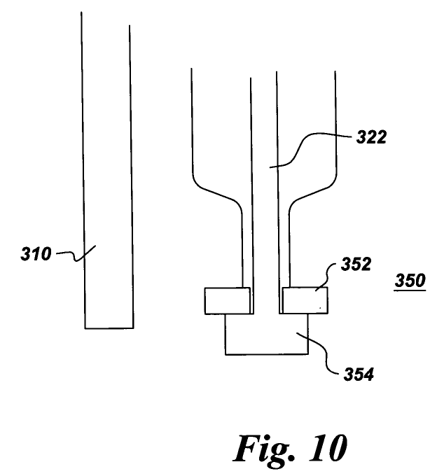

In one embodiment, shown in FIG. 9, the at least one retaining portion includes a second retaining portion 350, coupled to a bottom end of cylindrical support rod 322, distal from first retaining portion 326, which engages a top portion of cylindrical support rod 322. Second retaining portion 350 acts as a stop that prevents quartz rod from slipping downward and off cylindrical support rod 322. Such slippage may occur during or immediately following the sintering process, when quartz tube 340 is susceptible to breakage below flared end 342 and first retaining portion 326, and sometimes results in inadvertent destruction of quartz tube 340. In one embodiment, second retaining portion 350 comprises a circular disk, or segments of a circular disk, having a diameter that is greater than a diameter of the annular space within quartz rod 340. As seen in FIG. 9, second retaining portion 350, in one embodiment, forms an integral part of the bottom end of cylindrical support rod 322. In another embodiment, shown in FIG. 10, second retaining portion 350 comprises a separate circular disk 352 having an annular space through which cylindrical support rod 322 is slidingly inserted. The bottom end of cylindrical support rod 322 includes a stop 354 to capture circular disc 352.

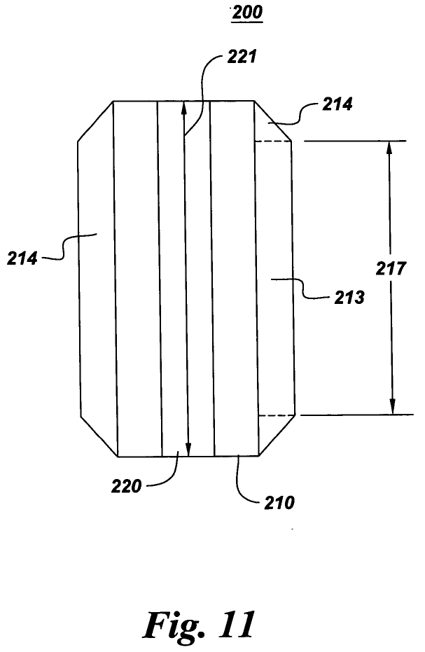

The present invention also provides a mandrel assembly for fabricating a quartz fiber optic sleeve tube. A mandrel assembly of the present invention is shown in FIG. 11. Mandrel assembly 200 comprises a quartz tube 210 having a cylindrical wall 212 and an outer layer 214 of silica soot deposited on an outer surface of cylindrical wall 212. Cylindrical wall 212 has an outer diameter 216 and inner diameter, which defines an annular space 218 having a substantially circular cross-section. A cylindrical support rod 220 straightens quartz tube 210 and minimizes tapering of the outer diameter due to creep. Cylindrical support rod 220 is disposed in annular space 218 such that cylindrical support rod 220 contacts quartz tube 210 at the temperature (also referred to hereinafter as the “sintering temperature”) at which the outer layer 214 of silica soot is sintered and consolidated with quartz tube 210. The sintering temperature is in the range from about 1400° C. to about 1600° C. and, preferably, between about 1450° C. and about 1550° C.

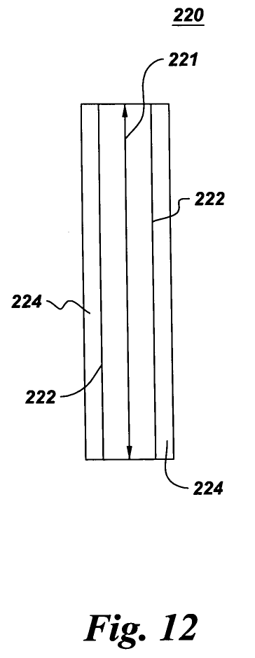

A cylindrical support rod 220 of the present invention is shown in FIG. 12. Cylindrical support rod 220 has a coefficient of thermal expansion that is greater than the coefficient of thermal expansion of quartz tube 210, and is substantially chemically inert with respect to silica in an atmosphere comprising an inert gas and at least one of fluorine, chlorine, and combinations thereof. In one embodiment, inner support rod assembly 220 is substantially chemically inert with respect to silica at temperatures of at least about 1400° C. in an atmosphere comprising helium and chlorine. Cylindrical support rod 220 has an outer surface 222 that contacts an inner surface of cylindrical wall 212 at the sintering temperature. Cylindrical support rod 220 has highly controlled dimensions. The outer surface 222 of cylindrical support rod 220 is substantially smooth, having a roughness of from about 0.1 micron to about 4 microns. In order to reduce bowing of quartz tube 210, cylindrical support rod 220 has a substantially circular cross-section and a minimal amount of bow. Ovality serves as a measure of the circularity of the cross-section of cylindrical support rod. In one embodiment, cylindrical support rod 220 has an ovality of up to about 0.35 mm and a bow of up to about 0.7 mm/m along its longitudinal axis.

In one embodiment, cylindrical support rod 220 comprises a carbonaceous material. In a preferred embodiment, cylindrical support rod 220 comprises graphite. The graphite is preferably heat treated in the presence of chlorine gas at about 2500° C. with a hold time of about 5 hours prior to use in cylindrical support rod 220, and has an ash content of less than about 100 parts per million (ppm). In one embodiment, cylindrical support rod 220 may further include a coating 224 disposed on outer surface 222. Outer coating 224 comprises at least one of graphite, amorphous carbon, and boron nitride. Outer coating 224 may be deposited by means known in the art, such as, but not limited to, chemical vapor deposition, and application of a slurry by either painting or spraying. In another embodiment, cylindrical support rod 220 comprises a cylindrical alumina core having a coating 224 disposed on an outer surface 222 of the cylindrical alumina core, where outer coating 224 comprises at least one of graphite, amorphous carbon, and boron nitride. In one embodiment, cylindrical support rod 220 is formed from a solid rod. Alternatively, cylindrical support rod 220 may be formed from a tubular piece of material, or from any combination of tubular and solid portions.

Outer layer 214 of silica soot comprises a central portion 213 having an outer surface 215 that is substantially parallel to cylindrical wall 212 of quartz tube 210 and a central portion length 217. Following sintering, in which the outer layer 214 of silica soot and the cylindrical wall 212 of quartz tube 210 are consolidated, central portion 213 will ultimately be used as a fiber optic sleeve tube. Cylindrical support rod provides support to quartz tube 210 along central portion length 217. In order to provide sufficient support for central portion 213, cylindrical support rod 220 has a rod length 221 that is a least as great as central portion length 217. Cylindrical support rod 220 should extend beyond both ends of central portion 213.

Quartz tube 210 has an inner diameter ranging from about 15 mm to about 50 mm. In one embodiment, quartz tube 210 has an inner diameter from about 18 mm to about 30 mm. Inner support tube 220 has an outer diameter that differs from inner diameter of quartz tube 210 by up to about 0.1 mm over the length of quartz tube 210.

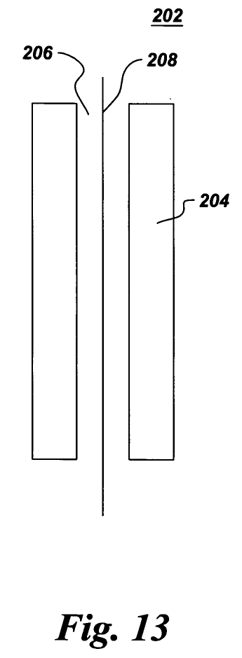

Mandrel assembly 200 is assembled by inserting cylindrical support rod 220 into annular space 218 of quartz tube 210, onto which an outer layer 214 of silica soot has been previously deposited. Cylindrical support rod 220 has been previously machined to minimize bow over its length. Materials, such as, for example, graphite, that are used to form cylindrical support rod 220 are easily machined to higher tolerances than those required for ovality specifications of quartz fiber optic sleeve tubes. A fiber optic sleeve tube (202 in FIG. 13) is formed from mandrel assembly 200 by sintering or consolidating outer layer 214 of silica soot and cylindrical wall 212 of quartz tube 210. Such sintering (also referred to hereinafter as “consolidation”) is performed by heating mandrel assembly 200 in a vertically oriented furnace to a temperature in the range from about 1400° C. to about 1600° C. and, preferably, between about 1400° C. and about 1550° C.

During consolidation, the silica soot sinters, and outer layer 214 of silica soot shrinks down onto the cylindrical wall 212 of quartz tube 210. Quartz tube 210 and outer layer 214 of silica soot shrink radially during consolidation, causing the inner diameter of cylindrical wall 214 to decrease while, at the same time, cylindrical support rod 220 expands with temperature. The initial diameter of cylindrical support rod 220 is chosen such that cylindrical support rod 220 has the desired diameter of the quartz fiber optic sleeve tube 202 at the sintering temperature. The quartz mandrel shrinks onto the expanded cylindrical support rod 220 and conforms to the shape and size of cylindrical support rod 220 at the sintering temperature, which, in one embodiment, is approximately 1500° C. Since the quartz conforms to the shape of cylindrical support rod 220 during sintering, the quartz fiber optic sleeve tube 202 produced by the present invention has less ovality than quartz fiber optic sleeve tubes 102 that are sintered without using cylindrical support rod 220.

At the sintering or consolidation temperature, cylindrical support rod 220 is stiff relative to quartz tube 210 and does not creep, and the amount of bow that can occur in the sintered sleeve tube is therefore minimized. When the sintering step is complete, the mandrel assembly 200 is removed from the furnace. Upon cooling, cylindrical support rod 220, which has a higher coefficient of thermal expansion than quartz, shrinks away from the consolidated, or sintered, outer layer 214 of silica soot and cylindrical wall 212 of quartz tube 210, allowing cylindrical support rod 220 to be easily removed from annular space 218. The end portions of consolidated outer layer 214 of silica soot and cylindrical wall 212 of quartz tube 210 are then removed, leaving consolidated central portion 213 intact as the fiber optic sleeve tube 202. The placement of cylindrical support rod 220 in annular space 218 consistently produces quartz fiber optic sleeve tubes having the same inner diameter.

Because quartz fiber optic sleeve tube 202 shrinks onto cylindrical support rod 220, fiber optic sleeve tube 202 experiences almost no axial shrinkage, whereas a fiber optic sleeve tube 202 produced without a cylindrical support rod 220 will experience axial shrinkage. In addition, using the cylindrical support rod 220 of the present invention during sintering allows an increased central portion length 217 of central portion 213 of outer layer 214 to be obtained on quartz tube 210. Thus, the size of usable central portion 213—and, ultimately, fiber optic sleeve tube 202—that can be formed in existing consolidation furnaces is increased.

A schematic representation of a quartz fiber optic sleeve tube 202 formed from mandrel assembly 200 is shown in FIG. 13. Consolidated wall 204 is substantially parallel to longitudinal axis 208 and exhibits little or no creep, sagging, or bowing. Inner diameter of aperture 206 has an ovality of up to about 0.5 mm and has a bow of less than about 0.7 mm/m along longitudinal axis 208.

The following example illustrates the advantages and various features of the present invention.

### EXAMPLE 1

Quartz soot was deposited on the outer surface of quartz tubes using flame hydrolysis. Thirty-three such tubes having an outer layer of quartz soot deposited thereon were prepared. A cylindrical graphite support rod of the present invention was inserted into the annular space of each of eight tubes to form a mandrel assembly of the present invention. Each of the eight mandrel assemblies was sintered at a temperature in a range from about 1400° C. to about 1500° C. The remaining twenty-five tubes were sintered at temperatures in a range from about 1400° C. to about 1500° C. without inserting the cylindrical support rod of the present invention. Dimensions, including cross-sectional area, inner diameter of the sintered tube, outer diameter taper of the sintered tube, bow, and ovality, of the sintered tubes were measured.

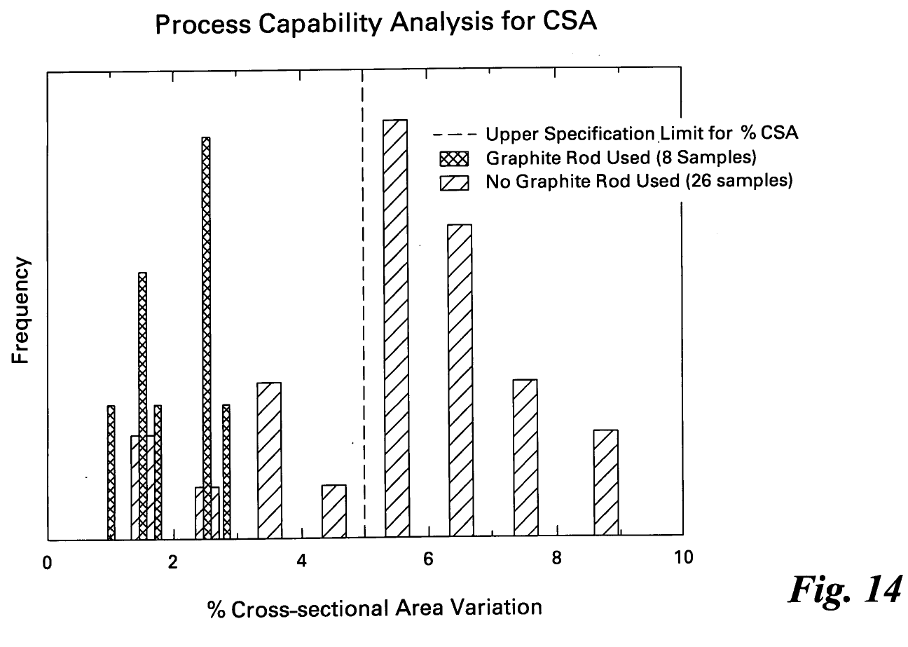

The variation of cross-sectional area (expressed in percent variation) measured for the quartz tubes that were sintered without inserting the cylindrical support rod of the present invention is plotted in FIG. 14. The mean percent variation was 5.4%, with a standard deviation of 1.82%.

The sintered quartz tubes that were incorporated into mandrel assemblies (i.e., the tubes having a support rod inserted into the annular space) exhibited a significant reduction in variation of cross-sectional area. The mean percent variation was 2.0%, with a standard deviation of 0.71%. The percent variation obtained for these quartz tubes is plotted in FIG. 14 and compared with the percent variation measured for the quartz tubes that were sintered without inserting the cylindrical support rod of the present invention.

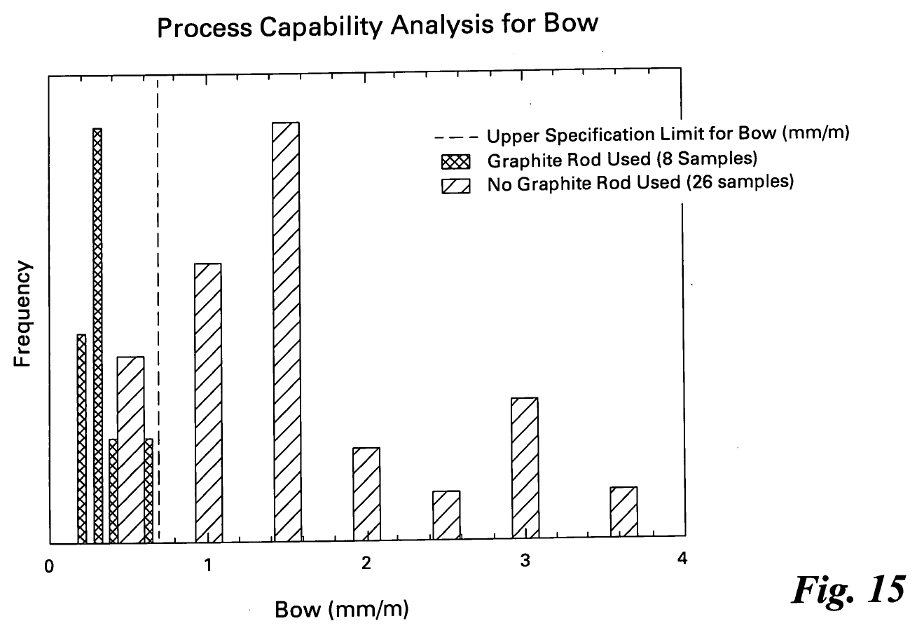

Values measured for bow for the quartz tubes that were sintered without inserting the cylindrical support rod of the present invention are plotted in FIG. 15. The mean value of bow was 1.54 mm, with a standard deviation of 0.82 mm.

The sintered quartz tubes that were incorporated into mandrel assemblies exhibited a significant reduction in bow. The mean value of bow was 0.32 mm, with a standard deviation of 0.15 mm. The bow values obtained for these quartz tubes are also plotted in FIG. 15 and compared with the percent variation measured for the quartz tubes that were sintered without inserting the cylindrical support rod of the present invention.

Ovality of the sintered quartz tubes was also improved when a support rod of the present invention was inserted in the annular space of a quartz tube prior to sintering. The average ovality of tubes that were sintered using the support rod was about 0.05 mm, whereas the ovality of tubes that were sintered using the support rod had an average value of about 0.2 mm.

Thus, the insertion of the support rod of the present invention into the annular space of quartz tubes prior to sintering provides a significant improvement in dimensional control over the current practice of sintering without such a support rod. Bow and ovality of the sintered tube are reduced, and the degree of variation of cross-sectional area is reduced as well. In addition, insertion of the support rod yields a sintered quartz tube having a more consistent inner diameter over its length and a reduced degree of creep.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A system for sintering a quartz tube, said quartz tube having a cylindrical wall defining an annular space and an outer layer of silica soot deposited on an outer surface thereof, said system comprising:
a) a furnace for heating said quartz tube to a temperature of at least 1400° C. in a controlled atmosphere, said furnace having a heating zone in which said quartz tube is sintered;
b) a support rod assembly disposable in said annular space, said support rod assembly comprising: (i) a cylindrical support rod having a central portion, said central portion having a surface roughness of from about 0.1 micron to about 4 microns, wherein said central portion has an ovality of up to about 0.5 mm and a bow of up to about 0.7 mm/m along a longitudinal axis of said support rod assembly, wherein said cylindrical support rod has a coefficient of thermal expansion that is greater than a coefficient of thermal expansion of said quartz tube, wherein said support rod assembly is substantially chemically inert with respect to silica in an atmosphere comprising an inert gas and at least one of fluorine, chlorine, and combinations thereof at temperatures of at least 1400° C., and wherein said support rod assembly straightens and supports said quartz tube and prevents tapering of said inner diameter due to creep; and (ii) at least one retaining portion coupled to said at least one end of said cylindrical support rod for preventing slippage of said quartz tube from said support rod assembly; and
c) means for positioning said support rod assembly and said quartz tube within said heating zone.

2. The system according to claim 2, wherein said central portion has an ovality of up to about 0.5 mm and a bow of up to about 0.7 mm/m along a longitudinal axis of said cylindrical support rod.

3. The system according to claim 1, wherein said central portion comprises a carbonaceous material.

4. The system according to claim 3, wherein said carbonaceous material comprises graphite.

5. The system according to claim 4, wherein said graphite has been purified in the presence of chlorine gas.

6. The system according to claim 4, wherein said central portion further includes a coating disposed on an outer surface of said central portion, wherein said coating comprises at least one of graphite deposited by chemical vapor deposition, amorphous carbon, and boron nitride.

7. The system according to claim 3, wherein said graphite has an ash content of less than 100 parts per million.

8. The system according to claim 1, wherein said central portion comprises a cylindrical alumina core and a coating disposed on an outer surface of said cylindrical alumina core, wherein said coating comprises at least one of graphite deposited by chemical vapor deposition, amorphous carbon, and boron nitride.

9. The system according to claim 1, wherein said central portion comprises a tubular structure.

10. The system according to claim 1, wherein said central portion comprises a solid rod.

11. The system according to claim 1, wherein said central portion has an outer diameter from about 15 mm to about 50 mm.

12. The system according to claim 1, wherein said central portion has a has an length from about 750 mm to about 1500 mm.

13. The system according to claim 1, wherein said quartz tube has an inner diameter and said central portion has an outer diameter, and wherein said inner diameter differs from said outer diameter by up to about 0.1 mm over the length of said central portion.

14. The system according to claim 1, wherein said at least one retaining portion comprises a coupling for engaging said means for positioning and at least one of a first end of said quartz tube and an end of said cylindrical support rod.

15. The system according to claim 14, further including a second retaining portion affixed to a second end of said cylindrical support rod and distal to said coupling.

16. The system according to claim 1, wherein said positioning means comprises a rod, wherein said rod is one of a quartz rod and a graphite rod, and wherein said positioning means is coupled to an external support structure.

17. The system according to claim 16, wherein said positioning means further includes a drive system coupled to said rod, wherein said drive system is capable of moving said quartz tube and said support rod assembly through said furnace.

18. The system according to claim 1, wherein said positioning means comprises a drive mechanism coupled to said furnace, wherein said drive mechanism is capable of moving said furnace relative to a longitudinal axis of said quartz tube.

19. The system according to claim 1, wherein said system is adapted to sinter a quartz fiber optic sleeve tube.

20. The system according to claim 1, wherein said controlled atmosphere comprises helium and at least one of and chlorine, fluorine, and combinations thereof.

21. A support rod assembly for supporting a quartz tube during sintering, said support rod assembly comprising:
a) a cylindrical support rod having a central portion, said central portion comprising a carbonaceous material and having a surface roughness of from about 0.1 micron to about 4 microns, wherein said central portion has an ovality of up to about 0.5 mm and a bow of up to about 0.7 mm/m along a longitudinal axis of said support rod assembly, wherein said central portion straightens and supports said quartz tube and prevents tapering of said inner diameter due to creep, and wherein said cylindrical support rod has a coefficient of thermal expansion that is greater than a coefficient of thermal expansion of said quartz tube and is substantially chemically inert with respect to silica in an atmosphere comprising an inert gas and at least one of fluorine, chlorine, and combinations thereof at temperatures of at least 1400° C.; and
b) at least one retaining portion coupled to said at least one end of said cylindrical support rod for preventing slippage of said quartz tube from said support rod assembly.

22. The support rod according to claim 21, wherein said carbonaceous material comprises graphite.

23. The support rod according to claim 22, wherein said graphite has been purified in the presence of chlorine gas.

24. The support rod according to claim 22, wherein said graphite has an ash content of up to about 100 parts per million.

25. The support rod assembly according to claim 21, wherein said cylindrical support rod further includes a coating disposed on an outer surface of said central portion, wherein said coating comprises at least one of graphite deposited by chemical vapor deposition, amorphous carbon, and boron nitride.

26. The support rod assembly according to claim 21, wherein said central portion comprises a tubular structure.

27. The support rod assembly according to claim 21, wherein said central portion comprises a solid rod.

28. The support rod assembly according to claim 21, wherein said central portion comprises a cylindrical alumina core and a coating disposed on an outer surface of said cylindrical alumina core, wherein said coating comprises at least one of graphite deposited by chemical vapor deposition, amorphous carbon, and boron nitride.

29. The system according to claim 21, wherein said central portion has an outer diameter from about 15 mm to about 50 mm.

30. The system according to claim 21, wherein said central portion has a length from about 750 mm to about 1500 mm.

31. The system according to claim 21, wherein said quartz tube has an inner diameter and said central portion has an outer diameter, and wherein said inner diameter differs from said outer diameter by up to about 0.1 mm over the length of said central portion.

32. The support rod assembly according to claim 21, wherein said at least one retaining portion comprises:
a) a first retaining portion affixed to a top end of said cylindrical support rod, wherein said first retaining portion engages at least one of a top end of said quartz tube and a top end of said cylindrical support rod, and wherein said first retaining portion prevents said quartz tube from slipping downward; and
b) a second retaining portion coupled to a bottom end of said cylindrical support rod for preventing said quartz tube from slipping off said support rod assembly.

33. The support rod assembly according to claim 21, wherein said atmosphere comprises helium and chlorine.

34. A system for sintering a quartz fiber optic sleeve tube, said system comprising:
a) a furnace for heating said quartz tube to a temperature of at least 1400° C. in a controlled atmosphere, said furnace having a heating zone in which said quartz tube is sintered;
b) a support rod assembly for supporting said quartz tube during sintering, said support rod assembly comprising: (i) a cylindrical support rod having a central portion, said central portion comprising a carbonaceous material and having a surface roughness of from about 0.1 micron to about 4 microns, wherein said central portion has an ovality of up to about 0.5 mm and a bow of up to about 0.7 mm/m along a longitudinal axis of said support rod assembly, wherein said central portion straightens and supports said quartz tube and prevents tapering of said inner diameter due to creep, and wherein said cylindrical support rod has a coefficient of thermal expansion that is greater than a coefficient of thermal expansion of said quartz tube and is substantially chemically inert with respect to silica in an atmosphere comprising an inert gas and at least one of fluorine, chlorine, and combinations thereof at temperatures of at least 1400° C.; and (ii) at least one retaining portion coupled to said at least one end of said cylindrical support rod for preventing slippage of said quartz tube from said support rod assembly; and
c) means for positioning said support rod assembly and said quartz tube within said heating zone.

35. The system according to claim 34, wherein said carbonaceous material comprises graphite.

36. The system according to claim 35, wherein said graphite has an ash content of up to about 100 parts per million.

37. The system according to claim 34, wherein said graphite has been purified in the presence of chlorine gas.

38. The system according to claim 34, wherein said central portion further includes a coating disposed on an outer surface of said central portion, wherein said coating comprises at least one of graphite deposited by chemical vapor deposition, amorphous carbon, and boron nitride.

39. The system according to claim 34, wherein said cylindrical support rod comprises a cylindrical alumina core and a coating disposed on an outer surface of said cylindrical alumina core, wherein said coating comprises at least one of graphite deposited by chemical vapor deposition, amorphous carbon, and boron nitride.

40. The system according to claim 34, wherein said central portion comprises a tubular structure.

41. The system according to claim 34, wherein said central portion comprises a solid rod.

42. The system according to claim 34, wherein said central portion has an outer diameter from about 15 mm to about 50 mm.

43. The system according to claim 34, wherein said central portion has a has a length from about 750 mm to about 1500 mm.

44. The system according to claim 34, wherein said quartz tube has an inner diameter and said central portion has an outer diameter, and wherein said inner diameter differs from said outer diameter by up to about 0.1 mm over the length of said central portion.

45. The system according to claim 34, wherein said at least one retaining portion comprises:
a) a first retaining portion affixed to a top end of said cylindrical support rod, wherein said first retaining portion engages at least one of a top end of said quartz tube and a top end of said cylindrical support rod, and wherein said first retaining portion prevents said quartz tube from slipping downward; and
b) a second retaining portion coupled to a bottom end of said cylindrical support rod for preventing said quartz tube from slipping off said support rod assembly.

46. The system according to claim 34, wherein said positioning means comprises a rod, wherein said rod is one of a quartz rod and a graphite rod, and wherein said positioning means is coupled to an external support structure.

47. The system according to claim 34, wherein said positioning means further include a drive system coupled to said rod, wherein said drive system is capable of moving said quartz tube and said support rod assembly through said furnace.

48. The system according to claim 34, wherein said positioning means comprises a drive mechanism coupled to said furnace, wherein said drive mechanism is capable of moving said furnace relative to a longitudinal axis of said quartz tube.

49. The system according to claim 21, wherein said atmosphere comprises helium and at least one of and chlorine, fluorine, and combinations thereof.

50. A method of making a quartz fiber optic sleeve tube, the method comprising the steps of:
a) providing a quartz tube, the quartz tube having a cylindrical wall defining an annular space and an outer layer of silica soot deposited on an outer surface thereof;
b) providing a cylindrical support rod, wherein the cylindrical support rod has an ovality of up to about 0.5 mm and has a bow of less than about of up to about 0.7 mm/m along its longitudinal axis, and wherein the cylindrical support rod has a coefficient of thermal expansion greater than a coefficient of thermal expansion of the quartz tube, and has a surface roughness of from about 0.1 micron to about 4 microns;
c) disposing the cylindrical support rod in the annular space of the quartz tube; and
d) consolidating the outer layer of silica soot and the quartz tube at a first temperature, wherein the cylindrical support rod supports the quartz tube at the first temperature, and wherein consolidating the outer layer of silica soot and the quartz tube at the first temperature forms the fiber optic sleeve tube.

51. The method according to claim 50, further comprising the step of removing the cylindrical support rod from the annular space following the step of consolidating the outer layer of silica soot and the quartz tube at a first temperature.

52. The method according to claim 50, wherein the first temperature is in a range from about 1450° C. to about 1550° C.

53. The method according to claim 50, wherein the cylindrical support rod comprises a carbonaceous material.

54. The method according to claim 50, wherein the cylindrical support rod comprises graphite.

55. The method according to claim 50, wherein the cylindrical support rod further comprises a coating disposed on an outer surface of the cylindrical support rod, wherein the coating comprises at least one of graphite, amorphous carbon, and boron nitride.

56. A quartz fiber optic sleeve tube, said quartz fiber optic sleeve tube comprising a cylindrical wall defining an annular space therein, said cylindrical wall being substantially parallel to a longitudinal axis, wherein said annular space has an ovality of up to about 0.5 mm and said quartz fiber optic sleeve tube has a bow of less than about of up to about 0.7 mm/m along said longitudinal axis, and wherein said quartz fiber optic sleeve tube is formed by:
a) providing a quartz tube, said quartz tube having a cylindrical wall defining an annular space and an outer layer of silica soot deposited on an outer surface thereof;
b) providing a cylindrical support rod, wherein said cylindrical support rod has a coefficient of thermal expansion that is greater than a coefficient of thermal expansion of said quartz tube, is substantially chemically inert with respect to silica in an atmosphere comprising an inert gas and at least one of fluorine, chlorine, and combinations thereof at temperatures of at least about 1400° C., has a surface roughness of from about 0.1 micron to about 4 microns, and has a bow of less than about of up to about 0.7 mm/m along said longitudinal axis;
c) disposing said cylindrical support rod in said annular space of said quartz tube; and
d) consolidating said outer layer of silica soot and said quartz tube at a first temperature, wherein said cylindrical support rod supports said quartz tube at said first temperature, and wherein and consolidating said outer layer of silica soot and the quartz tube at said first temperature forms said fiber optic sleeve tube.

57. A mandrel assembly for fabricating a quartz fiber optic sleeve tube, said mandrel assembly comprising:
a) a quartz tube, said quartz tube having a cylindrical wall defining an annular space and an outer layer of silica soot deposited on an outer surface thereof; and
b) a cylindrical support rod disposed in said annular space, wherein said cylindrical support rod has a coefficient of thermal expansion that is greater than a coefficient of thermal expansion of said quartz tube, is substantially chemically inert with respect to silica in an atmosphere comprising an inert gas and at least one of fluorine, chlorine, and combinations thereof at temperatures of at least 1400° C., and has a surface roughness of from about 0.1 micron to about 4 microns, and wherein said cylindrical support rod straightens and supports said quartz tube and prevents tapering of said inner diameter due to creep.

58. The mandrel assembly according to claim 57, wherein said cylindrical support rod has an ovality of up to about 0.5 mm and has a bow of up to about 0.7 mm/m along a longitudinal axis of said cylindrical support rod.

59. The mandrel assembly according to claim 57, wherein said cylindrical support rod comprises a carbonaceous material.

60. The mandrel assembly according to claim 59, wherein said carbonaceous material comprises graphite.

61. The mandrel assembly according to claim 60, wherein said graphite has been purified in the presence of chlorine gas.

62. The mandrel assembly according to claim 60, wherein said graphite has an ash content of less than 100 parts per million.

63. The mandrel assembly according to claim 60, wherein said cylindrical support rod further includes a coating disposed on an outer surface of said cylindrical support rod, wherein said coating comprises at least one of graphite deposited by chemical vapor deposition, amorphous carbon, and boron nitride.

64. The mandrel assembly according to claim 57, wherein said cylindrical support rod comprises a cylindrical alumina core and a coating disposed on an outer surface of said cylindrical alumina core, wherein said coating comprises at least one of graphite, wherein said graphite is deposited by chemical vapor deposition, amorphous carbon, and boron nitride.

65. The mandrel assembly according to claim 57, wherein said outer layer comprises a central portion having an outer surface that is substantially parallel to said cylindrical wall of said quartz tube and a central portion length, wherein said cylindrical support rod provides support to said quartz tube along said central portion length.

66. The mandrel assembly according to claim 65, wherein said cylindrical support rod has a rod length that is a least as long as said central portion length.

67. The mandrel assembly according to claim 57, wherein said quartz tube has an inner diameter from about 15 mm to about 55 mm.

68. The mandrel assembly according to claim 67, wherein said quartz tube has an inner diameter from about 18 mm to about 30 mm.

69. The mandrel assembly according to claim 57, wherein said quartz tube has an inner diameter and said cylindrical support rod has an outer diameter, and wherein said inner diameter differs from said outer diameter by up to about 0.1 mm over the length of said cylindrical support rod.

70. The mandrel assembly according to claim 57, wherein said central portion comprises a tubular structure.

71. The mandrel assembly according to claim 57, wherein said central portion comprises a solid rod.
